(19) United States
(12) Patent Application Publication
(10) Pub. No.: US 2006/0050328 A1
(43) Pub. Date: Mar. 9, 2006

(54) Scanner capable of quickly finding a leading edge of a document and a method therefor

(75) Inventor: Yen-Cheng Chen, Hsin Chu City (TW)

Correspondence Address: BIRCH STEWART KOLASCH & BIRCH, PO BOX 747, FALLS CHURCH, VA, 22040-0747, US

(73) Assignee: AVISION INC.

(21) Appl. No.: 11/207,868

(22) Filed: Aug. 22, 2005

(30) Foreign Application Priority Data
Sep. 3, 2004 (TW) 093126688

(51) Int. Cl. H04N 1/04

(52) U.S. Cl. 358/474

(57) ABSTRACT

A scanner capable of quickly finding a leading edge includes a scanning module for scanning a document, a moving mechanism for moving the scanning module, a non-volatile memory for storing leading edge position data, and a control processor. The control processor enables the scanning module to start to scan the document when the scanning module is moved by a leading edge distance corresponding to the leading edge position data and thus to obtain image data of the document. The leading edge position data is generated by scanning a standard template.

### BACKGROUND OF THE INVENTION

1. Field of the Invention

The invention relates to a scanner capable of quickly finding a leading edge and a method therefor, and more particularly to a scanner which is calibrated before being shipped out of the manufactory, such that the scanner can quickly find a leading edge of a document according to calibrated data.

2. Description of the Related Art

Before a scanner scans a document, the scanner has to perform the standard black/white calibration and to know when the image data of the document has to be acquired. That is, the scanner has to find a leading edge.

The methods of finding the leading edge in the conventional flatbed scanner have been disclosed in Taiwan Patent Publication Nos. 338868; 408552; and 462179; and U.S. Pat. Nos. 6,229,629; 6,392,762; and 6,480,317. In the above-disclosed methods, the scanning module has to read a mark, which defines a specific vector from a start-scanning point, such that the distance from the home position of the scanning module to the position of the start-scanning point is obtained. In such a kind of prior art methods, an element formed with the mark has to be additionally provided, and the mark has to be scanned, before each document-scanning process, as reference for calculating the start-scanning point. Thus, the time for each document-scanning process is longer.

The methods of finding the leading edge in a sheet-fed scanner have been disclosed in Taiwan Patent Publication No. 460404 and U.S. Pat. No. 5,715,071. The methods in the above-mentioned patents obtain the information about when the leading edge of the document will pass the scan region by detecting the designed data corresponding to the distance from the document detector to the scan region. The designed data is usually stored in a read only memory and cannot be modified in the subsequent calibrating procedure. The leading edge of the document cannot be correctly detected due to the existence of the assembling error and the different triggering time instants of the detectors. Thus, if the designed data serves as the reference for detecting the leading edge of the document, the significant error, which is a great hindrance to the trend of the scan quality getting higher and higher, will be inevitably generated due to the assembling error.

### SUMMARY OF THE INVENTION

It is therefore an object of the invention to provide a scanner capable of quickly finding a leading edge and a method therefor, wherein the scanner scans a standard template to generate leading edge position data and/or side edge position data as reference for finding the leading edge and/or a side edge before it is shipped out. Thus, the leading edge can be quickly found before a document is scanned.

To achieve the above-identified object, the invention provides a scanner capable of quickly finding a leading edge. The scanner includes a scanning module for scanning a document, a moving mechanism for moving the scanning module, a non-volatile memory for storing leading edge position data, and a control processor. The control processor enables the scanning module to start to scan the document when the scanning module is moved by a leading edge distance corresponding to the leading edge position data and thus to obtain image data of the document. The leading edge position data is generated according to a scanned standard template.

In addition, the non-volatile memory may also store side edge position data as reference for finding a side edge of the image data of the document.

### BRIEF DESCRIPTION OF THE DRAWINGS

FIG. 1 is a schematic illustration showing a scanner according to a first embodiment of the invention.

FIG. 2A is a schematic illustration showing a standard template of the invention.

FIG. 2B is a schematic illustration showing image data of the standard template and reference image data of the invention.

FIG. 3 is a schematic illustration showing a scanner according to a second embodiment of the invention.

### DETAILED DESCRIPTION OF THE INVENTION

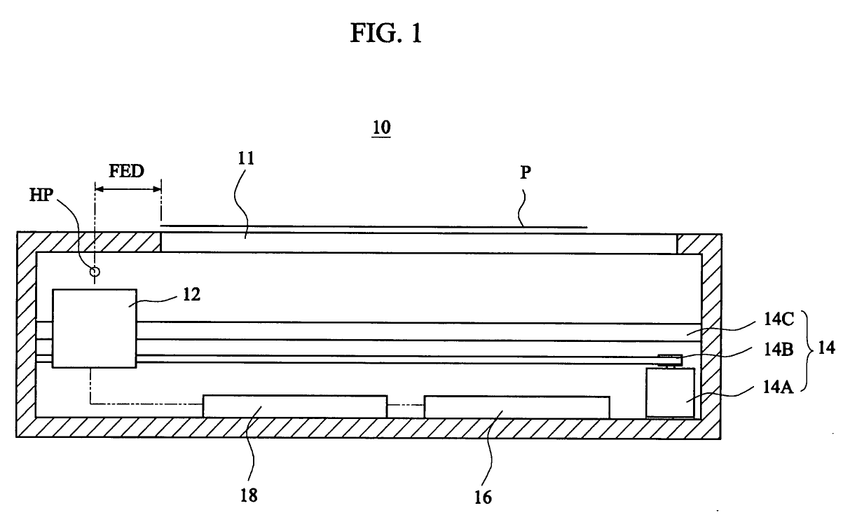

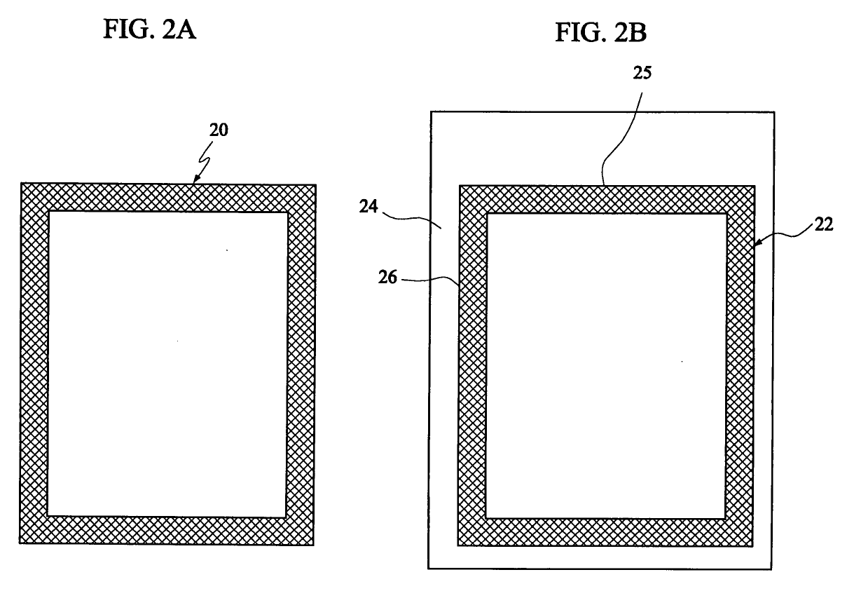

FIG. 1 is a schematic illustration showing a scanner according to a first embodiment of the invention. FIG. 2A is a schematic illustration showing a standard template of the invention. FIG. 2B is a schematic illustration showing image data of the standard template and reference image data of the invention. As shown in FIGS. 1, 2A and 2B, the scanner 10 of the invention capable of quickly finding a leading edge is a flatbed scanner, which includes a scanning module 12, a moving mechanism 14, a non-volatile memory 16 and a control processor 18. The scanning module 12 scans a document P. The moving mechanism 14 moves the scanning module 12. In another embodiment, the moving mechanism 14 moves the document P.

In this embodiment, the moving mechanism 14 is a scanning module moving mechanism for moving the scanning module 12 and includes, without limitation to, a motor 14A, a belt 14B and a guiding rod 14C. A leading edge distance FED is a shortest distance from a home position HP of the scanning module 12 to a document scan region 11 of the scanner.

The non-volatile memory 16 may be, for example, a non-volatile random access memory (NVRAM) or a flash memory for storing leading edge position data, such as a step number corresponding to a stepping motor. The control processor 18 enables the scanning module 12 to start to scan the document P to obtain image data of the document P when a relative movement between the scanning module 12 and the document P reaches a leading edge distance corresponding to the leading edge position data.

The scanning module 12 scans a standard template 20 and an area outside the standard template 20 to obtain image data 22 of the standard template 20 and reference image data 24. The control processor 18 processes the image data 22 of the standard template 20 and the reference image data 24 of the area outside the standard template 20 to obtain the leading edge position data. Then, the control processor 18 locates a leading edge 25 of the image data 22 of the standard template 20 by comparing the image data 22 of the standard template 20 with the reference image data 24, and counts a moving distance of the scanning module 12 moving from a home position HP to the position of the leading edge 25 to obtain the leading edge position data.

In addition to detecting the leading edge of the document, the scanner of the invention may also detect a side edge of the document. In this case, the non-volatile memory 16 may further store side edge position data as reference for finding a side edge of the image data of the document P.

In this case, the scanning module 12 scans the standard template 20 and the area outside the standard template 20 to obtain the image data 22 of the standard template 20 and the reference image data 24. The control processor 18 processes image data 22 of the standard template 20 and the reference image data 24 of the area outside the standard template 20 to obtain the leading edge position data and the side edge position data. Then, the control processor 18 locates the leading edge 25 and the side edge 26 of the image data 22 of the standard template 20 by comparing the image data 22 of the standard template 20 with the reference image data 24, and counts the moving distance of the scanning module 12 moving from the home position HP to the position of the leading edge 25 to obtain the leading edge position data and the side edge position data.

The method of finding a leading edge in a scanner will be described in the following.

First, the standard template 20 or the scanning module 12 is moved. Next, the relative moving distance between the standard template 20 and the scanning module 12 is counted. Then, the standard template 20 is scanned to obtain the image data 22 of the standard template 20 and the area outside the standard template 20 is scanned to obtain the reference image data 24. Next, the image data 22 of the standard template 20 and the reference image data 24 are compared with each other to obtain the leading edge 25 of the image data 22 of the standard template 20, such that the leading edge position data is obtained according to the relative moving distance. Furthermore, it is also possible to compare the image data 22 of the standard template 20 with the reference image data 24 to obtain the side edge 26 of the image data 22 of the standard template 20, such that the side edge position data is obtained. The side edge position data enables the scanner to define a side edge according to the side edge position data. Finally, the leading edge position data and the side edge position data are stored in the non-volatile memory 16.

After the leading edge position data and the side edge position data are obtained, the control processor 18 loads the leading edge position data and the side edge position data stored in the non-volatile memory 16. Then, the control processor 18 controls the moving mechanism 14 to move the scanning module 12 (or the document P) relative to the document P (or the scanning module 12) by a leading edge distance corresponding to the leading edge position data, and defines the side edge according to the side edge position data. Then, the document P may be scanned to obtain image data of the document.

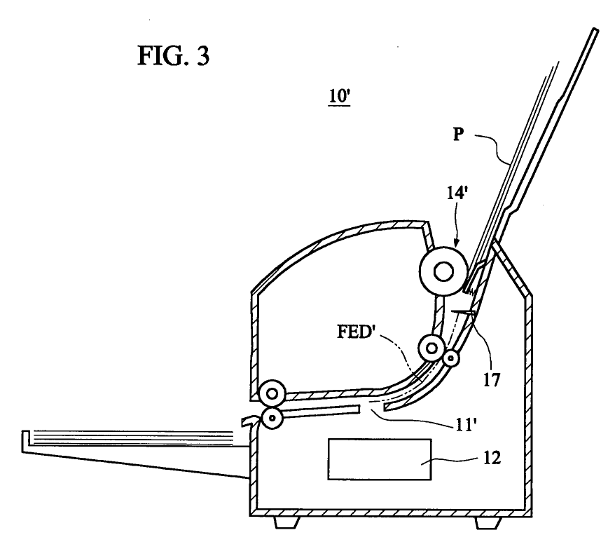

FIG. 3 is a schematic illustration showing a scanner according to a second embodiment of the invention. As shown in FIG. 3, the method of finding a leading edge in a sheet-fed scanner 10′ of this embodiment is similar to the first embodiment except that a moving mechanism 14′ is an automatic sheet-feeding mechanism for moving the document P, and a leading edge distance FED′ is the distance from a document detector 17 in the automatic sheet-feeding mechanism to a document scan region 11′ of the scanner. Using the scanning module 12 to scan the standard template and obtain the image data of the standard template during the calibrating operation can obtain the precise leading edge position data and the precise side edge position data as reference for finding the leading edge and the side edge in the subsequent document scanning processes.

It is to be noted that the above-mentioned calibrating operation may be made by the manufacturer before the scanner is shipped out, be made by the maintainer in the subsequent maintaining procedure, or be made by a user after the scanner has been used for a long time.

In the flatbed scanner using the method of finding the leading edge according to the invention, it is possible to omit the element formed with marks and to save the computing time before each scanning process. In the sheet-fed scanner using the method of finding the leading edge according to the invention, the assembling error and the leading edge detecting error caused by the trigger error of the detector may be effectively avoided. In addition, each scanner may generate its own leading edge position data and side edge position data, which are absolutely suitable for the operation of precisely finding the leading edge and the side edge, according to its own property by scanning the standard template before it is shipped out. Thus, the result of scanning the document is good, and the prior art drawbacks may be effective eliminated.

While the invention has been described by way of examples and in terms of preferred embodiments, it is to be understood that the invention is not limited to the disclosed embodiments. To the contrary, it is intended to cover various modifications. Therefore, the scope of the appended claims should be accorded the broadest interpretation so as to encompass all such modifications.

What is claimed is:

1. A scanner capable of quickly finding a leading edge, comprising:
a scanning module for scanning a document;
a moving mechanism for moving the scanning module;
a non-volatile memory for storing leading edge position data; and
a control processor for enabling the scanning module to start to scan the document when the scanning module is moved by a leading edge distance corresponding to the leading edge position data and thus to obtain image data of the document.

2. The scanner according to claim 1, wherein the leading edge distance is a shortest distance from a home position of the scanning module to a document scan region of the scanner.

3. The scanner according to claim 1, wherein the control processor processes image data of a standard template and reference image data of an area outside the standard template to obtain the leading edge position data, wherein the scanning module scans the standard template and the area outside the standard template to obtain the image data of the standard template and the reference image data.

4. The scanner according to claim 3, wherein the control processor locates a leading edge of the image data of the standard template by comparing the image data of the standard template with the reference image data, and counts a moving distance of the scanning module moving from a home position to a position of the leading edge to obtain the leading edge position data.

5. The scanner according to claim 1, wherein the non-volatile memory further stores side edge position data as reference for finding a side edge of the image data of the document.

6. The scanner according to claim 5, wherein the control processor processes image data of a standard template and reference image data of an area outside the standard template to obtain the leading edge position data and the side edge position data, wherein the scanning module scans the standard template and the area outside the standard template to obtain the image data of the standard template and the reference image data.

7. The scanner according to claim 6, wherein the control processor locates a leading edge and a side edge of the image data of the standard template by comparing the image data of the standard template with the reference image data, and counts a moving distance of the scanning module moving from a home position to a position of the leading edge to obtain the leading edge position data and the side edge position data.

8. The scanner according to claim 1, wherein the non-volatile memory is a non-volatile random access memory (NVRAM) or a flash memory.

9. A method of finding a leading edge in a scanner, comprising the steps of:
moving a standard template or a scanning module;
counting a relative moving distance between the standard template and the scanning module;
scanning the standard template to obtain image data of the standard template and an area outside the standard template to obtain reference image data;
comparing the image data of the standard template with the reference image data to obtain the leading edge of the image data of the standard template and obtaining leading edge position data according to the relative moving distance and the leading edge; and
storing the leading edge position data in a non-volatile memory.

10. The method according to claim 9, further comprising the step of:
comparing the image data of the standard template with the reference image data to obtain a side edge of the image data of the standard template so as to obtain side edge position data, being such that the scanner can define a side edge according to the side edge position data.

11. The method according to claim 9, wherein the non-volatile memory is a non-volatile random access memory (NVRAM) or a flash memory.

12. A method of finding a leading edge in a scanner, comprising the steps of:
loading leading edge position data stored in a non-volatile memory;
moving a scanning module by a leading edge distance corresponding to the leading edge position data; and
starting scanning a document to obtain image data of the document.

13. The method according to claim 12, further comprising the steps of:
loading side edge position data stored in the non-volatile memory; and
defining a side edge according to the side edge position data.

14. The method according to claim 12, wherein the non-volatile memory is a non-volatile random access memory (NVRAM) or a flash memory.
